(19) United States
(12) Patent Application Publication
(10) Pub. No.: US 2005/0063680 A1
(43) Pub. Date: Mar. 24, 2005

(54) Image recording apparatus

(76) Inventor: Eiichi Kito, Ashigara-Kami-Gun (JP)

Correspondence Address: BIRCH STEWART KOLASCH & BIRCH, PO BOX 747, FALLS CHURCH, VA, 22040-0747, US

(21) Appl. No.: 10/944,778

(22) Filed: Sep. 21, 2004

(30) Foreign Application Priority Data
Sep. 22, 2003 (JP) 2003-330323

(51) Int. Cl. H04N 5/76; H04N 5/225; H04N 5/781

(52) U.S. Cl. 386/117; 386/125

(57) ABSTRACT

The image recording apparatus comprises: an image recording device which records a first image on a recording medium; a control information recording device which records, on the recording medium, control information related to a subsequent image recording operation; and a control information reading device which reads the control information recorded on the recording medium, wherein a second image is recorded on the recording medium according to the control information read from the recording medium on which the first image and the control information have been recorded.

### BACKGROUND OF THE INVENTION

1. Field of the Invention

The present invention relates to an image recording apparatus, and more particularly to an image recording apparatus that can record images, text, and other data to both sides of a recording medium, and carry out additional recording to a recording medium that has already been recorded.

2. Description of the Related Art

Conventionally, in silver halide photograph prints, photosensitive materials are used on which an emulsified surface is formed on one side, so that images cannot be recorded to both sides of the photosensitive material, and there is as yet no apparatus that can record images to both sides of a photosensitive material in a so-called conventional silver halide mini-laboratory that uses the silver halide method to create prints. In addition, ink-jet methods, for example, do not impose any particular limitations on the recording medium, allow images to be recorded to normal paper, and make it possible to employ double-sided recording, but image quality with a conventional inkjet method falls far short of that with the silver halide method.

However, the inkjet method, electrophotographic method, and other image recording techniques have advanced in recent years, and images can now be recorded with image quality on a par with the silver halide method. A mini-laboratory can be set up in which double-sided recording is made possible using these recording methods, and a variety of image formation apparatuses that are capable of double-sided recording have been proposed.

Known, for example, are an inkjet printer (refer to Japanese Patent Application Publication No. 2001-353863, for example) in which ink discharge heads are disposed on both the front and reverse sides of the conveyed recording paper, enabling recording to both the front and reverse sides of the sheet recording paper; and an image formation apparatus (refer to Japanese Patent Application Publication No. 2002-1938, for example) with which images can be recorded on both sides of sheet paper by a process in which images are recorded with a first inkjet printer head to a first side of sheet paper conveyed in a rolled state in close contact with the peripheral portion of a first drum, the paper with the first side recorded is conveyed in a rolled state in close contact with the peripheral portion of a second drum disposed downstream from the first drum, and images are recorded on the second side of the paper with the second inkjet printer head.

Also known is a double-sided print apparatus (refer to Japanese Patent Application Publication No. 7-78143, for example) that prints to both sides of a paper by a process in which data for front-side printing to be printed on the front side of the paper is stored together with control information that designates the data for reverse-side printing to be printed to the reverse side in correlation to the data for front-side printing, the data for reverse-side printing is stored, the data for front-side printing and the control data are read during printing, the data for front-side printing is printed on the front side of paper, and the data for reverse-side printing is read and printed on the reverse side in a correlated manner on the basis of the control data.

Nevertheless, when an attempt is made to add a double-sided recording function to an inkjet printer or another image recording apparatus that is capable of double-sided recording, two recording heads must be provided as cited in Japanese Patent Application Publication Nos. 2001-353863 and 2002-1938. Moreover, as in the apparatus described in Japanese Patent Application Publication No. 7-78143, there are disadvantages that a mechanism is needed for reversing the paper; memory must be installed for storing the data for front-side printing, control information, and data for reverse-side printing; the apparatus configuration is complicated; costs are potentially higher; the size of the apparatus larger; and the like.

It is convenient if a mini-laboratory has double-sided recording function for creating postcards because a large amount of recording can be rapidly carried out with high quality. However, single-sided recording is common for photographic prints, and the demand for the creation of large quantities of postcards is normally seasonal, as is the case with Christmas cards, and with other special occasions, so that even providing a mini-laboratory provided with a double-sided recording function would not prevent a situation in which the use of the double-sided recording function may possibly be limited to a short period of time in a year. Therefore, adding a double-sided recording function leads to higher costs and a larger apparatus for that function alone, and such a situation is difficult to justify from the viewpoint of marketing strategy.

### SUMMARY OF THE INVENTION

The present invention has been contrived in view of such circumstances, and an object thereof is to provide an image recording apparatus that can easily perform double-sided recording or additional recording to a recording medium without complicating the structure, and can rapidly record a large quantity of images with photographic image quality.

In order to attain the above-described object, the present invention is directed to an image recording apparatus, comprising: an image recording device which records a first image on a recording medium; a control information recording device which records, on the recording medium, control information related to a subsequent image recording operation; and a control information reading device which reads the control information recorded on the recording medium, wherein a second image is recorded on the recording medium according to the control information read from the recording medium on which the first image and the control information have been recorded.

According to the present invention, images can again be recorded with the same image recording device to a recording medium to which images have once been recorded, so that other images and the like can be further recorded to the recording medium to which images have been recorded without complicating the structure of the image recording device.

In an aspect of the present invention, the first image is recorded on a first side of the recording medium; the control information includes information related to the second image to be recorded on a second side of the recording medium reverse to the first side; and the second image is recorded on the second side of the recording medium according to the control information at the subsequent image recording operation. Images can thereby be recorded on both sides of a recording medium.

In another aspect of the present invention, the image recorded with the image recording device includes text; at least a portion of the text constitutes the control information; and the image recording device also serves as the control information recording device. By using the addressee information and other information as control information in postcard printing, for example, images can be recorded simultaneously with control information by the image-recording device, and the recording area for the control information in particular does not need to be reserved.

In another aspect of the present invention, the control information includes information related to an arrangement on the recording medium of the image recorded on the recording medium by the image recording device; and the second image is recorded with a predetermined size in a predetermined position on the recording medium according to the control information at the subsequent image recording operation. Additional images can thereby be recorded easily and automatically without editing on a previously recorded recording medium. Preferably, the control information is also additionally recorded when the second image is recorded on the recording medium at the subsequent image recording operation. It is possible to additionally record any number of times by also recording the control information at each additional recording.

In another aspect of the present invention, the recording medium is a sheet of cut paper; and a conveyance path is substantially linear, the recording medium being conveyed through the conveyance path from a recording medium supply unit to the image recording device, the control information recording device, and the control information reading device. Since the conveyance path is linear, double-sided recording can also be carried out on thick paper without the recording medium becoming bent during conveyance.

Preferably, a reading position of the control information reading device is varied according to a thickness of the recording medium. Control information can be accurately read in this manner without regard to the thickness of the recording medium, from thin to thick media, by moving the position of the control information reading device up and down, for example.

In another aspect of the present invention, the image recording device also serves as the control information recording device and records the control information in the image with invisible ink or records the control information in the image as watermark information. Thus, a recording area for the control information does not need to be reserved on the surface of the recording medium because the control information is concealed in the image.

In the image recording apparatus according to the present invention as described above, it is possible to perform additional recording to a recording medium that has once been recorded, such as double-sided recording to a recording medium, and to record images to an already recorded recording medium for a second time, for example, without complicating the configuration of the apparatus.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a block diagram showing the schematic configuration of an ink-jet mini-laboratory as an embodiment of the image recording apparatus of the present invention;

FIG. 2 is a block diagram showing the schematic configuration of the portion related to recording images to the recording paper of FIG. 1;

FIG. 3 is a table showing examples of front-side print control data and reverse-side print control data in the case of album prints;

FIG. 4 is diagram showing an example of an album print recorded on the front side of the recording paper;

FIG. 5 is a table showing examples of front-side print control data and reverse-side print control data in the case of postcards;

FIG. 6 is diagram showing an example of the first print when an image is additionally recorded later; and

FIG. 7 is diagram showing an example the case in which additional recording is made to the print in FIG. 6.

### DETAILED DESCRIPTION OF THE PREFERRED EMBODIMENTS

The image recording apparatus according to the present invention is described in detail below with reference to the attached diagrams.

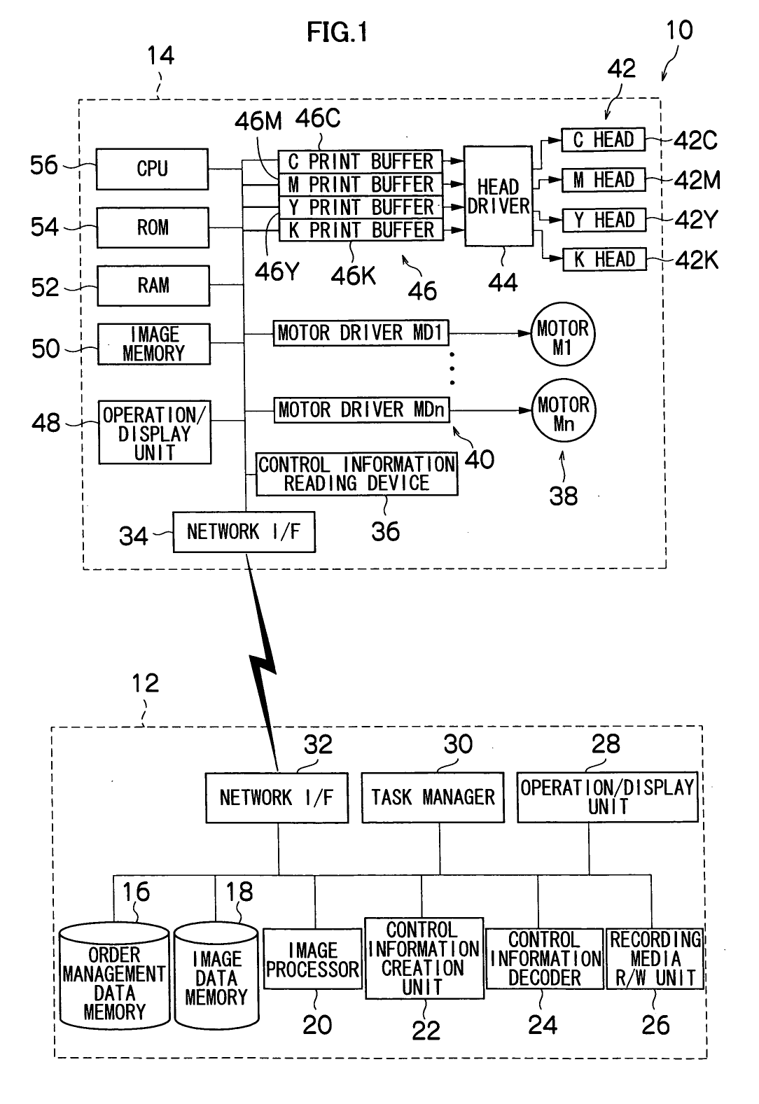

FIG. 1 is a block diagram showing the schematic configuration of an ink-jet mini-laboratory according to an embodiment of the image recording apparatus of the present invention. The image recording apparatus of the present embodiment has an inkjet head for recording images with the inkjet method, and is a mini-laboratory that can rapidly perform double-sided recording or additionally record a large quantity of images with about the same high quality as silver halide photography. The image recording apparatus of the present invention is not limited to such inkjet methods, and the xerographic method or other electrophotographic methods may also be used.

The image recording apparatus 10 of the present embodiment is an ink-jet mini-laboratory in which an order management/image processing device 12 and printer 14 are connected to a network to form a print system, as shown in FIG. 1.

The order management/image processing device 12 is composed of an order management data memory 16, image data memory 18, image processor 20, control information creation unit 22, control information decoder 24, image media reading and writing (R/W) unit 26, operation/display unit 28, task manager 30, and network interface (I/F) 32.

Order management data memory 16 stores the data (order management information) for managing the order from the customer, and image data memory 18 stores the image data and the like of order requests from the customer. The image processor 20 carries out predetermined image data processing in accordance with the image when the image is recorded in conjunction with the customer's order.

The control information creation unit 22 creates control information as a barcode or other code information related to the next and subsequent image recordings in correlation with the recording images. Examples of this control information include information for designating images to be recorded to the reverse side of the recording paper on which the images have already been recorded, as well as information that is related to the arrangement of recorded images on the recording paper and that is used to designate the areas previously recorded and to be able to additionally record other images or the like to vacant areas or other areas on the recording paper.

For recording convenience, the control information is converted to a code and is recorded to a predetermined position on the recording paper. The control information decoder 24 decodes the control information expressed in the code read from the recording paper when recording an image for a second time.

When a customer has placed an order and has brought a medium to which data has been recorded, the recording media R/W unit 26 reads image data and outputs processed image data from and to the medium. When the operator operates the order management/image processing device 12, various instructions are inputted through the operation/display unit 28, which displays the processing image, the instruction contents, and the like for augmenting the operation of the operator.

The task manager 30 manages tasks to be carried out by the order management/image processing device 12. The network I/F 32 is an interface unit for connecting the order management/image processing 12 and the printer 14 by way of the network.

The printer 14 is networked with the order management/image processing device 12 by way of a network I/F 34, and is composed of a control information reading device 36; a motor 38 (motor M1, . . . , motor Mn); a motor driver 40 (motor driver MD1, . . . , motor driver MDn); a recording head 42 composed of color heads (C head 42C, M head 42M, Y head 42Y, and black head 42K) for discharging each of the inks cyan (C), magenta (M), yellow (Y), and black (K); a print buffer 46 composed of print buffers (C print buffer 46C, M print buffer 46M, Y print buffer 46Y, and black print buffer 46K) for the colors; an operation/display unit 48; an image memory 50; a RAM 52; a ROM 54; and a CPU 56.

The control information reading device 36 reads from the recording paper the control information containing image information that is to be subsequently recorded when images are recorded for a second time to recording paper on which images have already been recorded once (such as in cases in which, for example, other images are recorded to the reverse side of the recording paper on which images have already been recorded, or other images are additionally recorded to the front side).

The motor 38 and the motor driver 40 for driving the motor 38 are used as the driving force sources for the conveyance roller that conveys the recording paper, for the cutter that cuts the recording paper in the form of a rolled sheet to a predetermined print size, and for other components in the printer 14.

The recording head 42 (42C, 42M, 42Y, and 42K) for each color is controlled by the head driver 44 on the basis of print data of the print buffer 46 (46C, 46M, 46Y, and 46K) for each color, and records images to the recording paper. In the present embodiment, an ink-jet head is used as the recording head 42, but the present invention is not limited to the ink-jet method, and the xerographic method or other electrophotographic methods may also be used as described above.

The operation/display unit 48 is used when the operator issues instructions to the printer 14 while viewing the display, and the image memory 50 stores the image data to be printed that is sent from the order management/image processing device 12 over the network. The RAM 52 and the ROM 54 hold software required for the operation of the printer 14, as well as data and other information. The CPU 56 serves as the work area when the printer 14 is operated, and controls the operation of each of the components of the printer 14.

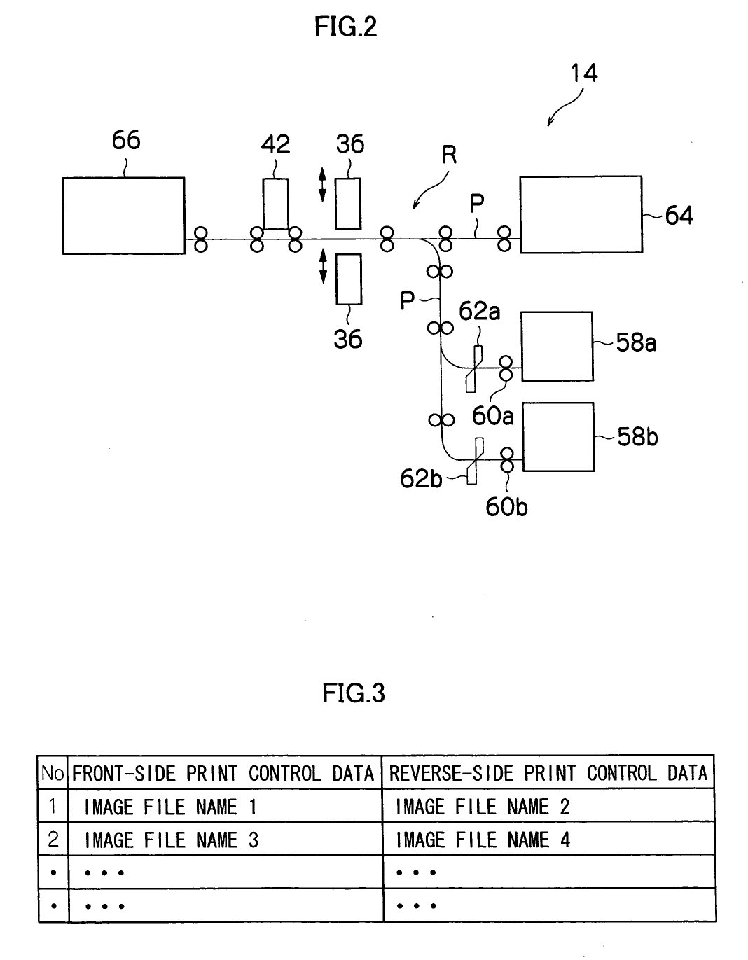

FIG. 2 is a block diagram showing the schematic configuration of the portion related to recording images to the recording paper of printer 14.

The printer 14 controls the image recording actions to the recording paper with a configuration such as the one shown in FIG. 1, but actual image recording entails the use of paper magazines 58a and 58b in which recording paper wound in the form of a roll is stored, draw rollers 60a and 60b for drawing out recording paper from the respective paper magazines 58a and 58b, cutters 62a and 62b for cutting the drawn out recording paper to a predetermined length in accordance with the print, and a sheet supply stocker 64 for storing recording paper (cut paper) cut in the form of sheets to a predetermined length.

A plurality of conveyance rollers convey recording paper P drawn from the paper magazines 58a and 58b and cut in the form of sheets to a predetermined length, or the recording paper P in the form of sheets that is fed from the sheet supply stocker 64.

In the stage prior to the recording head 42 (inkjet printer head), the control information reading device 36 (control information read sensor) is disposed for reading the control information recorded on the recording paper P when recording images for a second time to the recording paper that has already been recorded. The control information may be recorded on the front side of the recording paper P, but there are also cases in which control information is recorded on the reverse side, so that the control information reading device 36 is provided to both the front and reverse sides of the recording paper P. The control information reading device 36 is movable with respect to the recording paper P as represented with two-headed arrows in FIG. 2, in order to vary the reading position of the control information reading device 36 according to the thickness of the recording paper P.

Disposed in the stage following the recording head 42 is a sorter 66; recording paper P on which images have been recorded by the recording head 42 are accumulated therein; and the paper is discharged as completed prints one sheet at a time. The conveyance path R, which extends to the sorter 66 from the sheet supply stocker 64 by way of the control information reading device 36 and the recording head 42, has a linear shape as shown in FIG. 2. For this reason, the recording paper P can be prevented from being bent during conveyance, and double-sided recording and other recording operations can be easily carried out even with thick paper.

The operation of the image recording apparatus 10 (inkjet mini-laboratory) of the present embodiment is described below.

Following is a description of an example of creating double-sided prints by recording images for a second time to the reverse side of recording paper on which images have already been recorded. The case in which album prints are created is described as a first example of double-sided prints.

When a request for the creation of album prints is received from the customer, the operator in advance of printing creates print control data and print data by registering order management data and image data in the order management/image processing device 12. More specifically, order management data and image data are read by the recording media R/W unit 26 from the recording media containing print information brought in by customer, and are respectively registered in the order management database of the order management data memory 16 and the image database of the image data memory 18.

The order management data includes the order ID number, front-side print control data, and reverse-side print control data. Here, the order ID number is a number for identifying an order. The front-side print control data and the reverse-side print control data are types of data that show the print content recorded on the front and reverse sides, respectively, of the recording paper P, and the content thereof differs according to the print object.

Examples of front-side print control data and reverse-side print control data in the case of an album print are shown in FIG. 3. The front-side print control data and the reverse-side print control data show the image file names that specify the images to be recorded to the front side of each print, and the image file names that specify the images to be recorded to the reverse side in correlation with the images recorded on the front side, as shown in FIG. 3.

When printing the front side of the recording paper P, the operator inputs the order ID number through the operation/display unit 28 of the order management/image processing device 12. When the order ID number is inputted, the front-side print control data and the reverse-side print control data corresponding to the order ID number are read from the order management database of the order management data memory 16. The image data contained in the image file name 1 recorded in the front-side print control data as shown in FIG. 3 is read from the image database of the image data memory 18, sent to the image processor 20, and developed as print data. The print data is sent from the network I/F 32 to the printer 14 by way of the network.

The image file name 2 recorded in the reverse-side print control data is sent to the control information creation unit 22, converted to a barcode in the control information creation unit 22, and sent from the network 1F 32 to the printer 14 by way of the network.

The print data and control information sent from the order management/image processing device 12 to the printer 14 over the network are stored in the image memory 50. The printer 14 then begins printing when the front-side print data and the control information are available.

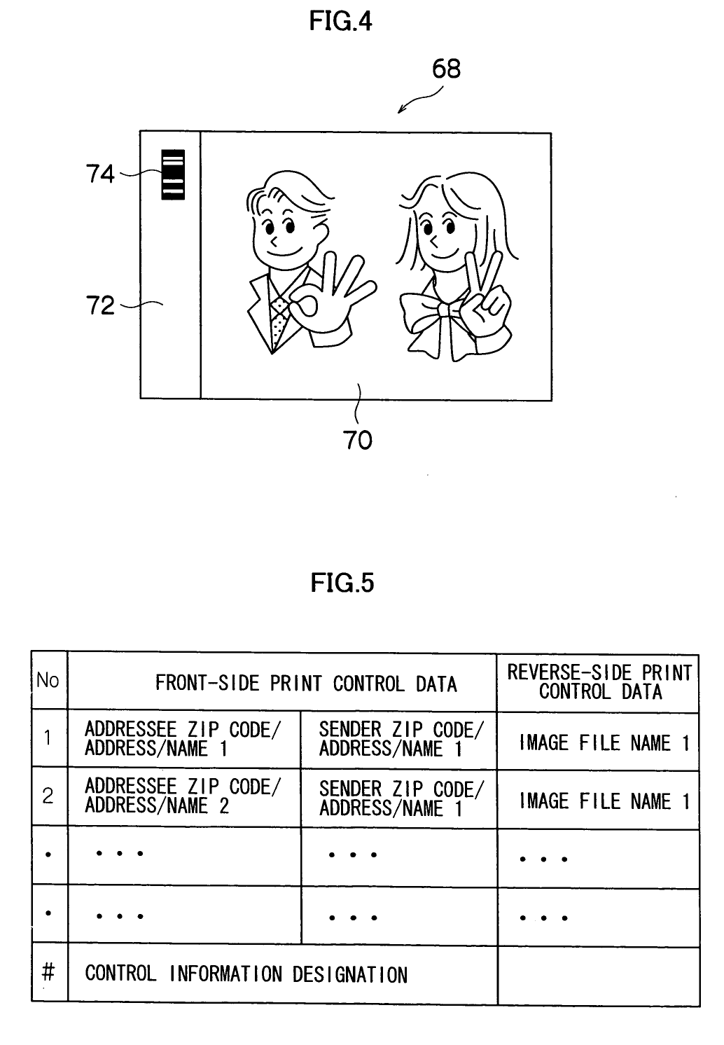

FIG. 4 shows an example of an album print recorded (printed) on the front side of recording paper P. The album print 68 is composed of an image area 70 and a gutter margin 72, the front-side print data is recorded to the image area 70 on the basis of the print data, and the control information 74 is recorded as a barcode to the gutter margin 72 on the basis of the control information, as shown in FIG. 4.

In the present embodiment, the print data and the control information are recorded by the same recording head 42, but a recording head for recording the image data (print data) and a recording head for recording the control information may be separately provided. In the present embodiment, control information 74 was recorded to the gutter margin 72, but the control information may be recording on the reverse side when double-sided printing is used. However, when recording the control information to the reverse side, a recording head for recording control information to the reverse side of recording paper P must be provided.

Thereafter, sheet recording paper P is conveyed, recording paper P that has already been recorded is stored in the sorter 66, recording is carried out until the unprocessed front-side print control data and reverse-side print control data in the image memory 50 is completely processed, and the prints for a single project is received in the sorter 66.

When performing printing to the reverse side in the subsequent cycle, the operator removes the prints for the single project received in the sorter 66, turns the prints over, and sets the prints in the sheet supply stocker 64. The prints whose front side has already been printed are turned over and set in the sheet supply stocker 64, and when an instruction to begin printing is issued from the operation/display unit 48, each of the prints is conveyed from the sheet supply stocker 64, and the control information 74 recorded in the gutter margin 72 of the front side of the print is read by the control information reading device 36.

The control information read by the control information reading device 36 is sent to the control information decoder 24 of the order management/image processing device 12 over the network. The control information in the barcode is decoded in the control information decoder 24 into the image file name indicating the image to be recorded to the reverse side. The image data corresponding to this image file name is read from the image database of the image data memory 18 and is developed into print data in the image processor 20, and the data is sent from the network 1F 32 to the printer 14 side over the network.

The printer 14 carries out reverse-side printing to the reverse side of recording paper P when print data is received. Thereafter, reverse-side printing is repeated until the previously recorded recording paper (print) set in the sheet supply stocker 64 is completed processed.

Thus, when recording for an album print project is completed, the album prints for this project are removed from the sorter 66, and binding the prints along the gutter margin 72 creates an album in the form of a book. The control information 74 is recorded in the gutter margin 72, so that the appearance of the album is not diminished because the information is no longer visible when the album is bound.

Next, the creation of postcards is described as another example of double-sided printing.

When an order is received from a customer for the creation of postcards, the operator first creates print control data and print data. This is the same as in the above-described case of creating an album print. More specifically, print information containing the order management data and the image data is read from the customer's recording medium by the recording media R/W unit 26 for each order, and is recorded to the order management database of the order management data memory 16 and the image database of the image data memory 18.

FIG. 5 shows examples of front-side print control data and reverse-side print control data in the case of postcards.

In the case of postcards, the front-side print control data is composed of information that indicates the addressee and information that indicates the sender, and the reverse-side print control data is composed of the image file name and other information specifying the image to be printed to the reverse side, as shown in FIG. 5. In the case of postcards, images to be printed to the reverse side are often the same, as shown in FIG. 5. Also in the case of postcards, there is no gutter margin as there is in the album prints described above, so that control information is preferably not recorded with a barcode or other method to the front side.

In view of the above, the addressee information (all or part) is used as the control information in the case of postcards. For this reason, a control information designation column that shows which portion of the addressee information is the control information is provided. In this case, the print format of the addressee is already determined, so that the position thereof alone needs to be designated in the control information designation column. When printing thereafter to the reverse side, solely the portion designated in the control information designation column needs to be read by the control information reading device 36.

Next, the operator inputs the order ID number through the operation/display unit 28 of the order management/image processing device 12. When the order ID number is inputted, the front-side print control data and the reverse-side print control data corresponding to the order ID number are read from their respective databases. The addressee information and sender information (including the recording position information) recorded in the front-side print control data are sent to the image processor 20, developed as print data, and sent to the printer 14 over the network.

The printer 14 prints the addressee name and other information to the front side of the postcard on the basis of the print data thus sent. At this time, all or a portion of the addressee information and other information is contained in the control information, so that the control information is also recorded at the same time by recording the addressee information and other information (front-side print data) with the recording head 42, as described above. In other words, the print data and control information are simultaneously recorded without the need to record control information separately from so-called print data.

Printing is repeated until the front-side print control data and reverse-side print control data are completely processed, and the prints for a single project are received in the sorter 66.

Next, when printing to the reverse side, the operator turns over the postcards which have been received in the sorter 66 and whose front side is recorded with the addressee information and other information, sets the postcards in the sheet supply stocker 64, and issues an instruction with the operation/display unit 48 to begin printing. The control information reading device 36 reads the control information as each of the postcards is conveyed during printing. At this time, all or a portion of the addressee information and other information is read on the basis of the control information designation column, and the information is sent to the control information decoder 24 of the order management/image processing device 12 over the network.

The control information decoder 24 extracts text information, which is the addressee information and other information, and creates name and address information. The items and recording positions used as control information in the control information designation column of the front-side print control data are recorded at this time, so that text extraction and conversion can be efficiently carried out.

Next, the image file name corresponding to the control information (name and address) is searched from the order management data, and the image data to be printed to the reverse side of the postcard in correlation with the image file name is read from the image database. The data is developed into print data in the image processor 20 and sent to the printer 14 over the network.

When the printer 14 receives the print data, the print data is printed to the reverse side of the corresponding postcard. Thereafter, recording to the reverse side is repeated until the prints (postcards) set in the sheet supply stocker 64 are processed.

In the case of postcards, the reverse-side image is often the same, so when there is no change in the image data to be printed to the reverse side, it is preferable to process the image data without resending the data from the order management/image-processing device 12 to the printer 14.

When, for example, all of the reverse-side print data are the same in a single order, the operator issues an instruction through the operation/display unit 48 so that the control information is read for the first print alone by the control information reading device 36 during reverse-side recording, and the data of the first print is repeatedly used thereafter as the print data for recording to the reverse side. Alternatively, when all of the control data is read and there is no change in the image data to be printed to the reverse side, the image data is read and printing is carried out with the processed image data of a single print without acquiring further data.

An example of printing to both sides of a recording paper is described above. Following is a description of a case in which an image is additionally recorded to a vacant area of the front side of the recording paper.

When a blank space (vacant area of the image) is created in an album print or other type of print, for example, additional recording can be performed to the blank space at a later time, and the layout information (information related to the arrangement of recording images) for indicating the vacant area is recorded as control information to achieve this purpose.

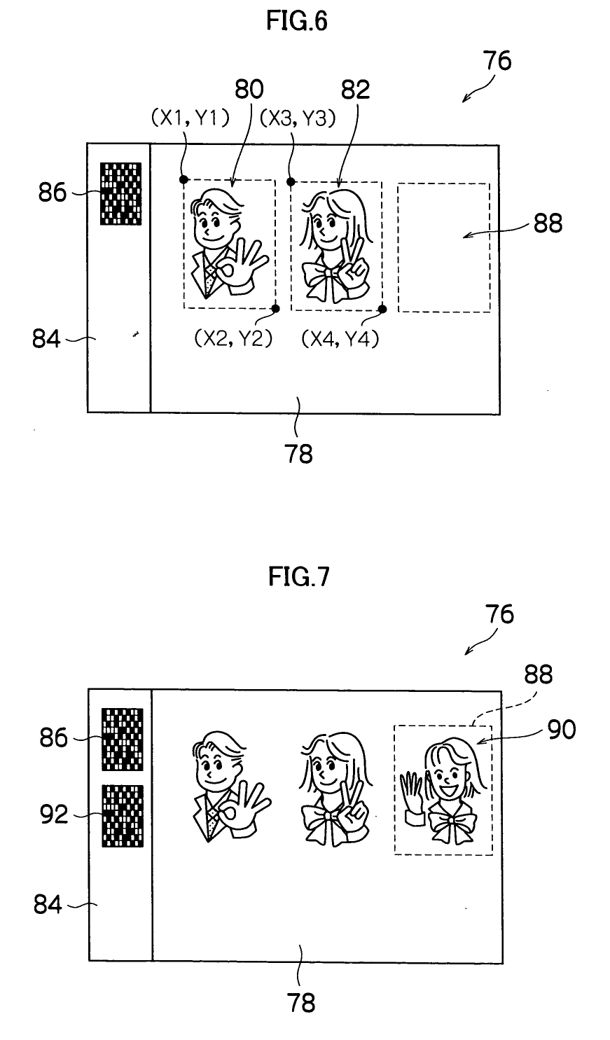

The first print is essentially the same as the album print described above. An example of this print is shown in FIG. 6. The print 76 in the case of later additional recording is configured such that the images 80 and 82 are recorded to the image area 78, and the layout information of the recorded images 80 and 82 is recorded to the gutter margin 84 as control information 86, as shown in FIG. 6. More specifically, the coordinates (X1, Y1), (X2, Y2), and (X3, Y3), (X4, Y4) of the two vertices on the diagonal lines of rectangles indicating the respective image recording areas of the recording images 80 and 82 are recorded as layout information. In this case, the amount of information is considerable, and control information 86 is preferably recorded as a two-dimensional barcode, as shown in FIG. 6. A vacant area (blank space) 88 is present at this time in the image area 78, as shown in FIG. 6.

When forming a second or subsequent print at a later time on the previously recorded recording paper (print) as an additional recording, the operator first inputs the order data of the additional recording requested by the customer through the operation/display unit 28 of the order management/image processing device 12. The image file containing all of the images to be additionally recorded is read from the recording media R/W unit 26, and recorded to the image database of the image data memory 18.

Prints which are to be additionally recorded and for which control information is recorded are set in the sheet supply stocker 64 of the printer 14, and an instruction is issued to begin printing. During print conveyance, the control information reading device 36 reads the control information 86 showing the layout information represented as the two-dimensional barcode, and sends the information to the control information decoder 24 of the order management/image processing device 12 over the network.

The control information decoder 24 decodes the two-dimensional barcode, specifies the area in which images are already recorded, and provides this information to the image processor 20. The image processor 20 determines the position and size of the images to be additionally recorded from the image data to be recorded and the information containing the area in which images are already recorded; and the images are furthermore corrected as required, developed into print data, and sent to the printer 14 over the network.

When the printer 14 receives the print data, an additional image 90 is recorded to the vacant area 88 of the image area 78, as shown in FIG. 7. At this time, the layout information related to the additional image 90 is recorded as the control information 92 of another two-dimensional bar code.

Also at this time, the control information 92 to be additionally recorded may include not only the layout information related to the additional images 90, but also layout information obtained by computation of the entire area in which images have been recorded by additional recording. When this configuration is not adopted, the entire recording area is ultimately found by computation from the information obtained by reading both the control information 86 in the first image recording and the control information 92 in the additional second recording, and the vacant area is ultimately found. When, however, an additional recording is made and the layout information indicating the areas in which all the images are recorded is additionally recorded at that time as control information 92, the vacant area can be quickly found by reading solely the control information 92 recorded in the previous additional recording, and additional recording to a vacant area can be easily carried out when such additional recording is carried out yet again.

It is difficult to make additional recordings when coating treatment has been performed to impart a gloss to the print surface during the previous recording. In view of this, recording control information indicating that a coating treatment or other treatment has been performed makes it possible to learn from the control information during additional recording that coating treatment has been performed, allowing additional recording to be canceled or another operation to be carried out in such a case.

In the example of additional recording described above, the layout (arrangement) was determined so that the images previously recorded and the images to be additionally recorded do not overlap, by it is also possible to overwrite images previously recorded with images to be additionally recorded so as to add persons who were absent from an album print or another group photograph.

As described above in the examples described in the present embodiment, images containing text are recorded on the recording paper, control information related to subsequent image recordings is recorded, previously recorded recording paper (print) is set again in the supply unit (sheet supply stocker) of the printer and is recorded during a subsequent image recording, control information previously recorded on the recording paper is read, and images are recorded for a second time on the basis of the control information by being recorded to the reverse side or additionally recorded to vacant areas on the same side. Further image recording can thereby be carried out to recording paper that has previously been recorded, such as double-sided printing and additional recording, without complicating the structure of the printer.

Here, the control information is information related to subsequent image recording, but more specifically it is possible to include various types of information in this information. For example, recorded as control information is information (image file name or other information, for example) for specifying images that correspond to images on the front side when recording images to the reverse side, layout-related information (positional information or other layout information indicating the area in which images have previously been recorded, for example) indicating vacant areas when additionally recording to the same side, or information indicating the fact that coating treatment or another treatment has been performed on the print surface during a previous printing.

Thus, in the present embodiment, double-sided printing is possible, and recording paper (print) that has previously been recorded is manually set again in the supply unit, so that a mechanism for reversing the recording paper for double-side recording is not required, the structure of the printer is kept simple, and a miniaturized, low cost apparatus can be created. Resetting the prints is performed manually, but a switch back step and the like are not required if batch processing is implemented, so that high-speed processing is possible by providing a reversing mechanism to automatically print to both sides.

To print on the reverse side, the image data to be recorded to the reverse side is specified by control information, so when the prints are set in the supply unit, there is no need to take into account the order of printing or to input the order ID or other information, and high-speed processing can be thereby ensured. When information (layout information) related to the arrangement of recorded images is recorded as control information, additional recording is easily achieved. In this case, additional recording can be performed automatically without any editing by determining the recording position and size of the images to be additionally recorded, on the basis of information related to the arrangement of the images. If the control information is also additionally recorded at each additional recording, then it is possible to additionally record images any number of times as long as a vacant area is available.

The control information may be recorded in invisible ink, or the information can be recorded within an image as watermark information. The need to secure recording area for control information is thereby dispensed with and recording paper can be effectively used without wasting recording paper.

In an image recording apparatus having a plurality of paper (recording paper) supply units, the conveyance path for the recording paper from the sheet supply stocker is substantially linearly formed, so that it is possible to easily print on both sides of not only regular thin paper, but also thick paper. By varying the vertical position of the control information reading device in accordance with the thickness of the recording paper at this time, control information can be accurately read from thin paper as well as thick paper, without regard to the thickness of the recording paper.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. An image recording apparatus, comprising:
an image recording device which records a first image on a recording medium;
a control information recording device which records, on the recording medium, control information related to a subsequent image recording operation; and
a control information reading device which reads the control information recorded on the recording medium,
wherein a second image is recorded on the recording medium according to the control information read from the recording medium on which the first image and the control information have been recorded.

2. The image recording apparatus as defined in claim 1, wherein:
the first image is recorded on a first side of the recording medium;
the control information includes information related to the second image to be recorded on a second side of the recording medium reverse to the first side; and
the second image is recorded on the second side of the recording medium according to the control information at the subsequent image recording operation.

3. The image recording apparatus as defined in claim 1, wherein:
the image recorded with the image recording device includes text;
at least a portion of the text constitutes the control information; and
the image recording device also serves as the control information recording device.

4. The image recording apparatus as defined in claim 1, wherein:
the control information includes information related to an arrangement on the recording medium of the image recorded on the recording medium by the image recording device; and
the second image is recorded with a predetermined size in a predetermined position on the recording medium according to the control information at the subsequent image recording operation.

5. The image recording apparatus as defined in claim 4, wherein the control information is also additionally recorded when the second image is recorded on the recording medium at the subsequent image recording operation.

6. The image recording apparatus as defined in claim 1, wherein:
the recording medium is a sheet of cut paper; and
a conveyance path is substantially linear, the recording medium being conveyed through the conveyance path from a recording medium supply unit to the image recording device, the control information recording device, and the control information reading device.

7. The image recording apparatus as defined in claim 1, wherein a reading position of the control information reading device is varied according to a thickness of the recording medium.

8. The image recording apparatus as defined in claim 1, wherein the image recording device also serves as the control information recording device and records the control information in the image with invisible ink.

9. The image recording apparatus as defined in claim 1, wherein the image recording device also serves as the control information recording device and records the control information in the image as watermark information.
